(19) United States
(12) Patent Application Publication
(10) Pub. No.: US 2006/0198454 A1
(43) Pub. Date: Sep. 7, 2006

(54) Adaptive channel estimation thresholds in a layered modulation system

(75) Inventors: Seong Taek Chung, Redwood City, CA (US); Rajiv Vijayan, San Diego, CA (US)

Correspondence Address: QUALCOMM INCORPORATED, 5775 MOREHOUSE DR., SAN DIEGO, CA, 92121, US

(73) Assignee: QUALCOMM Incorporated

(21) Appl. No.: 11/329,717

(22) Filed: Jan. 10, 2006

Related U.S. Application Data
(60) Provisional application No. 60/658,266, filed on Mar. 2, 2005.

(51) Int. Cl. H04K 1/10

(52) U.S. Cl. 375/260

(57) ABSTRACT

Dynamic channel estimation thresholds allow for determining optimal threshold values for channel estimation in a layered-modulation wireless communication system. A channel estimation threshold can be used to remove or otherwise filter out channel estimate components that may be significantly influenced by noise. The channel estimation threshold value can be used to generate a refined channel estimate that is used in decoding multiple layers of a layered modulation signal. The channel estimation threshold value can be varied based on the performance of the various signal layer decoders. The adaptive channel estimation threshold provides for decoding a base layer based on an optimal threshold value for the base layer; determining an error rate associated with decoding the base layer; and using an optimal threshold value for an enhancement layer in a channel estimation algorithm if the error rate is lower than a predetermined level.

### CROSS-REFERENCES TO RELATED APPLICATIONS

Claim of Priority under 35 U.S.C. §119

The present Application for Patent claims priority to Provisional Application No. 60/658,266 entitled “METHOD AND APPARATUS FOR DETERMINING ADAPTIVE THRESHOLDS IN A LAYERED-MODULATION COMMUNICATION SYSTEM” filed Mar. 2, 2005, and assigned to the assignee hereof and hereby expressly incorporated by reference herein.

Reference to Co-Pending Applications for Patent

The present Application for Patent is related to the following co-pending U.S. Patent Application “METHOD AND APPARATUS FOR DECODING DATA IN A LAYERED MODULATION SYSTEM” by Rajiv Vijayan, having Attorney Docket No. 040524, filed concurrently herewith, assigned to the assignee hereof, and expressly incorporated by reference herein.

### BACKGROUND OF THE INVENTION

Wireless communication systems are continually striving to increase the data bandwidth so that information can quickly be exchanged between devices coupled to the communication system. Some of the parameters that limit the data bandwidth available to devices include the spectral bandwidth allocated to the devices and the quality of the channel linking the devices.

Wireless communication systems compensate for the various constraints on data bandwidth using a variety of techniques. A wireless communication system may incorporate multiple encoding techniques, and may select an encoding technique based on a data rate supported by a channel. In such a system, the communicating devices may negotiate a data rate based on the capabilities of the channel. Such a communication system may be advantageous for multiple point to point links, but may be less than ideal in a distributed broadcast system where a single transmitter provides substantially the same data to multiple receivers.

Wireless communication systems may incorporate hierarchical modulation, also referred to as layered modulation, where multiple data streams are simultaneously transmitted across a hierarchy of data layers. The multiple data streams can include a base layer that is a robust communication link capable of successful reception in nearly all receiver operating conditions. The multiple data streams can also include an enhancement layer that is broadcast at a data rate that is lower, the same, or higher than the data rate of the base layer. The communications over the enhancement layer may require a higher signal quality at the receiver compared to the base layer. Therefore, the enhancement layer may be more sensitive to variations in the quality of the channel.

The receiver is typically ensured the ability to communicate at the base level, and can typically demodulate data on the base layer. In channel conditions sufficient to support the enhancement layer, the receiver is also able to demodulate additional data modulated on the enhancement layer to provide a higher quality of service or to provide additional data bandwidth.

Orthogonal Frequency Division Multiplex (OFDM) is a multi-carrier modulation technique that effectively partitions the overall system bandwidth into multiple (N) orthogonal subbands. These subbands are also referred to as tones, subcarriers, bins, and frequency channels. With OFDM, each subband is associated with a respective subcarrier that may be modulated with data. Each subcarrier in an OFDM symbol can be configured to independently support layered modulation data.

The use of layered modulation signals substantially complicates the receiver operation. However, the receiver may be a portable receiver that has limited power capacity or limited processing capabilities. The complications to the receiver arising from the incorporation of layered modulation operate in contrast to efforts to reduce the size, power consumption, and cost of a receiver.

### BRIEF SUMMARY OF THE INVENTION

Dynamic channel estimation thresholds allow for determining optimal threshold values for channel estimation in a layered-modulation wireless communication system. A channel estimation threshold can be used to remove or otherwise filter out channel estimate components that may be significantly influenced by noise. The channel estimation threshold value can be used to generate a refined channel estimate that is used in decoding multiple layers of a layered modulation signal. The channel estimation threshold value can be varied based on the performance of the various signal layer decoders. The channel estimation threshold value can be varied to maintain a target quality of service or a target range of quality of service. The range of quality of service can be determined based on a quality of service at a base layer and an enhancement layer.

The adaptive channel estimation threshold provides for decoding a base layer based on an optimal threshold value for the base layer; determining an error rate associated with decoding the base layer; and using an optimal threshold value for an enhancement layer in a channel estimation algorithm if the error rate is lower than a predetermined level.

Aspects of the invention include a method of adapting a channel estimation threshold value in a layered modulation system. The method includes determining a quality of service from a base layer of a received OFDM symbol modulated with layered modulation, and varying the channel estimation threshold value based on the quality of service.

Aspects of the invention include a method of adapting a channel estimation threshold value in a layered modulation system. The method includes a) setting a threshold coefficient to a value that is optimized for a base layer, b) determining an energy estimate from a turbo decoder of the base layer, and c) setting threshold coefficient to the value optimized for the enhancement layer if the energy estimate is greater than a lower boundary value.

Aspects of the invention include a receiver in a layered modulation system. The receiver includes a RF front end configured to receive a layered modulation symbol over a wireless link, a channel estimator coupled to the RF front end and configured to generate a channel estimate based on the layered modulation symbol and a variable channel estimation threshold value, a symbol deinterleaver coupled to the RF front end and configured to extract a base layer symbol and an enhancement layer symbol from the layered modulation symbol, a base layer decoder coupled to the symbol deinterleaver and configured to determine a base layer data from the base layer symbol and the channel estimate, and an enhancement layer decoder coupled to the symbol deinterleaver and configured to determine an enhancement layer data from the enhancement layer symbol and the channel estimate.

Aspects of the invention include a processor readable storage device configured to store one or more processor usable instructions. The instructions include determining a quality of service from a base layer of a received OFDM symbol modulated with layered modulation, and varying the channel estimation threshold value based on the quality of service.

Aspects of the invention include a receiver in a layered modulation system. The receiver includes means for determining a quality of service from a base layer of a received OFDM symbol modulated with layered modulation, and means for varying the channel estimation threshold value based on the quality of service.

Aspects of the invention include a receiver in a layered modulation system. The receiver includes means for setting a threshold coefficient to a first value, means for determining an energy estimate from a turbo decoder of a base layer, and means for setting the threshold coefficient to a second value if the energy estimate is greater than a lower boundary value.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a functional block diagram of an embodiment of a wireless communication system incorporating layered modulation.

FIGS. 2A-2B are constellation diagrams of an embodiment of layered modulation.

FIG. 3 is a functional block diagram of an embodiment of a transmitter configured for a layered coded modulation system.

FIG. 4A is a functional block diagram of an embodiment of a receiver configured for operation in a layered modulation system.

FIG. 4B is a functional block diagram of an embodiment of a channel estimation module in a receiver.

FIG. 5 is a graph of the boundary values and the corresponding signal quality metric.

FIG. 6 is a plot of LLR versus relevant part of the received signal for an embodiment of enhancement layer data.

FIG. 7 is a plot of LLR versus relevant part of the received signal for an embodiment of base layer data.

FIG. 8 is a simplified functional block diagram of an embodiment of a transmitter configured for a layered coded modulation system.

FIG. 9 is a simplified functional block diagram of an embodiment of a receiver configured for operation in a layered modulation system.

FIG. 10 is a simplified functional block diagram of an embodiment of a channel estimation module in a receiver.

FIG. 11 is a simplified flowchart of a method of adapting a channel estimation threshold value in a layered modulation system.

FIG. 12 is a simplified flowchart of a method of adapting a channel estimation threshold value in a layered modulation system.

### DETAILED DESCRIPTION OF THE INVENTION

The disclosed embodiments provide methods and apparatus for adaptively or otherwise dynamically determining a channel estimation threshold value. A receiver can adaptively or dynamically determine the channel estimation threshold value based on a quality of service of the received signal. A receiver can determine a quality of service or signal quality on a base layer or some other lower layer of a layered modulation signal. The receiver can also determine a quality of service or signal quality on an enhancement layer or some other upper layer of the layered modulation signal. The receiver can compare the quality of service against predetermined quality of service thresholds and can adjust or otherwise vary the channel estimation threshold based on the received quality of service.

The threshold value can be varied using at least the error rate in the base layer in order to determine the threshold value for channel estimation when two or more layers are transmitted in a layered-modulation system. According to one embodiment, the receiver decodes the base layer based on a threshold optimized for the base layer. Then, the receiver checks an error rate, such as a symbol error rate or packet error rate, for the base layer. If the error rate of the base layer is low, for example lower than an acceptable signal quality threshold, then the receiver switches the threshold value of the channel estimation algorithm to a different value, such as the value optimized for the enhancement layer for channel estimation. The channel estimation threshold value can be changed in one or more predefined step sizes. Accordingly, when the enhancement layer has a reasonable error rate, then the base layer can experience good, although perhaps suboptimal performance. Hence, even though the threshold for the base layer may not be optimized, the performance degradation will likely be within an acceptable range.

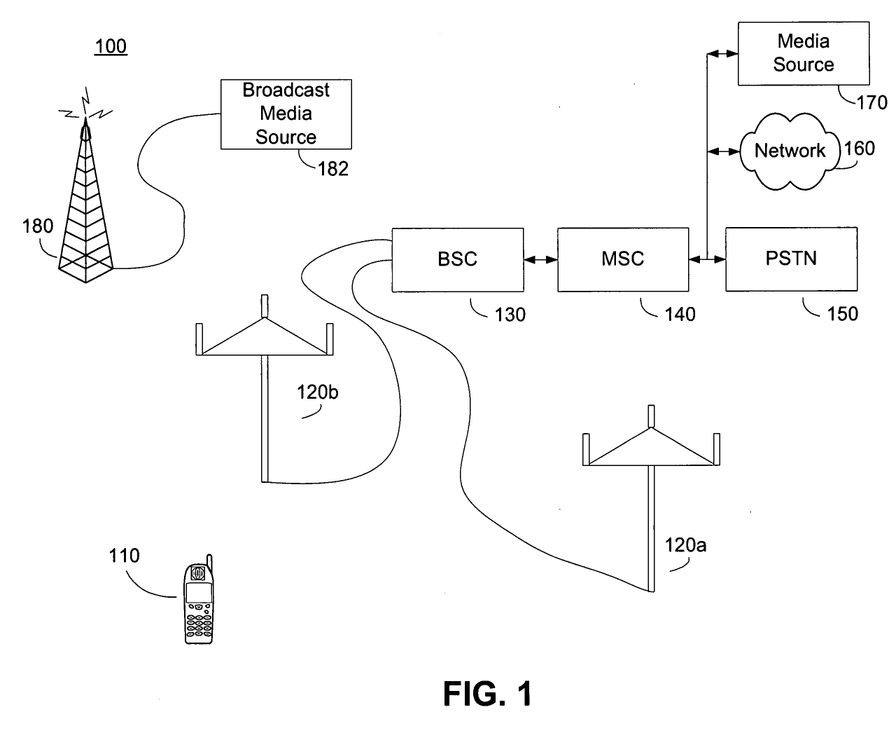

FIG. 1 is a functional block diagram of an embodiment of a wireless communication system 100 incorporating hierarchical modulation, alternatively referred to as layered modulation. The system includes one or more fixed elements that can be in communication with a user terminal 110. The user terminal 110 can be, for example, a wireless telephone configured to operate according to one or more communication standards using layered modulation. For example, the user terminal 110 can be configured to receive wireless telephone signals from a first communication network and can be configured to receive data and information from a second communication network. In some embodiments, both communication networks can implement layered modulation, while in other embodiments, one of the communication networks may implement layered coded modulation.

The user terminal 110 can be a portable unit, a mobile unit, or, a stationary unit. The user terminal 110 may also be referred to as a mobile unit, a mobile terminal, a mobile station, user equipment, a portable, a phone, and the like. Although only a single user terminal 110 is shown in FIG. 1, it is understood that a typical wireless communication system 100 has the ability to communicate with multiple user terminals 110.

The user terminal 110 typically communicates with one or more base stations 120a or 120b, here depicted as sectored cellular towers. The user terminal 110 will typically communicate with the base station, for example 120b, that provides the strongest signal strength at a receiver within the user terminal 110.

Each of the base stations 120a and 120b can be coupled to a Base Station Controller (BSC) 140 that routes the communication signals to and from the appropriate base stations 120a and 120b. The BSC 140 is coupled to a Mobile Switching Center (MSC) 150 that can be configured to operate as an interface between the user terminal 110 and a Public Switched Telephone Network (PSTN) 150. The MSC can also be configured to operate as an interface between the user terminal 110 and a network 160. The network 160 can be, for example, a Local Area Network (LAN) or a Wide Area Network (WAN). In one embodiment, the network 160 includes the Internet. Therefore, the MSC 150 is coupled to the PSTN 150 and network 160. The MSC 150 can also be coupled to one or more media source 170. The media source 170 can be, for example, a library of media offered by a system provider that can be accessed by the user terminal 110. For example, the system provider may provide video or some other form of media that can be accessed on demand by the user terminal 110. The MSC 150 can also be configured to coordinate inter-system handoffs with other communication systems (not shown).

In one embodiment, the base stations 120a and 120b can be configured to transmit layered modulation signals to the user terminal 110. For example, the base stations 120a and 120b can be configured to transmit a multicast signal that can be directed to the user terminal 110 as well as other receivers (not shown). The layered modulation signals can include a base layer signal that is configured to be robust, and an enhancement layer signal that operates at a lower link margin, and as a result, that is more sensitive to variations in the channel. The enhancement layer can be configured to provide supplemental data to the data supplied on the base layer or provide independent data that has a lower quality of service requirement.

The wireless communication system 100 can also include a broadcast transmitter 180 that is configured to transmit a layered modulation signal to the user terminal 110. In one embodiment, the broadcast transmitter 180 can be associated with the base stations 120a and 120b. In another embodiment, the broadcast transmitter 180 can be distinct from, and independent of, the wireless telephone system containing the base stations 120a and 120b. The broadcast transmitter 180 can be, but is not limited to, an audio transmitter, a video transmitter, a radio transmitter, a television transmitter, and the like or some combination of transmitters. Although only one broadcast transmitter 180 is shown in the wireless communication system 100, the wireless communication system 100 can be configured to support multiple broadcast transmitters 180. A plurality of broadcast transmitters 180 can transmit signals in overlapping coverage areas. A user terminal 110 can concurrently receive signals from a plurality of broadcast transmitters 180. The plurality of broadcast transmitters 180 can be configured to broadcast identical, distinct, or similar broadcast signals. For example, a second broadcast transmitter having a coverage area that overlaps the coverage area of the first broadcast transmitter may also broadcast some of the information broadcast by a first broadcast transmitter.

The broadcast transmitter 180 can be configured to receive data from a broadcast media source 182 and can be configured to hierarchically code the data, modulate a signal based on the hierarchically coded data, and broadcast the modulated hierarchically coded data to a service area where it can be received by the user terminal 110. The broadcast transmitter 180 can generate, for example, base layer data and enhancement layer data from data received from the broadcast media source 182.

The layered modulation data configuration can be advantageous if the enhancement layer does not carry data that is redundant to that carried on the base layer. Additionally, the inability of the receiver to decode the enhancement layer may not result in loss of service. For example, the base layer can be configured to deliver video at a standard video resolution, and the enhancement layer can provide additional data that increases the resolution or SNR of the received video signal. In another embodiment, the base layer can be configured to provide a signal having a predetermined quality, such as a video signal at 15 frames per second, and the enhancement layer can be configured to supplement the information carried on the base layer. For example, the enhancement layer can be configured to carry information used to support a video signal at 30 frames per second. In such a configuration, the inability to decode the enhancement layer data results in lower resolution signal, lower signal quality, or SNR, but not a complete loss of signal.

The user terminal 110 can be configured to demodulate the received signal and decode the base layer. The receiver in the user terminal 110 can implement error control mechanisms as a standard part of the base layer decoder. The receiver in the user terminal 110 can use the error control mechanisms of the base layer decoder to determine a probability of successful enhancement layer decoding. The receiver in the user terminal 110 can then determine whether to decode the enhancement layer based on statistics or metrics generated in the error control mechanisms used in the base layer decoding.

In another embodiment, the user terminal 110 can be configured to substantially decode the base layer and enhancement layers concurrently, without relying on base layer information when decoding the enhancement layer. For example, the user terminal 110 can be configured to determine a single decoder threshold value and use the single decoder threshold value when decoding both the base and enhancement layer. The decoder threshold can be based in part on a characteristic of the layered modulation data. For example, the decoder threshold can be based on a ratio of the power or energy of the enhancement layer relative to the base layer. The decoder threshold can also be based in part on a desired error rate, such as a symbol error rate, bit error rate, packet error rate, or frame error rate. The decoder threshold can be fixed or may vary based, for example, on varying desired quality of service or varying characteristics of the layered modulation data.

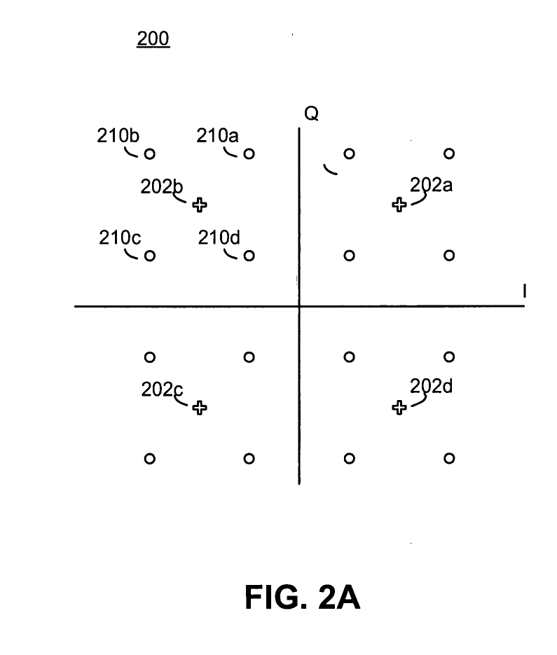

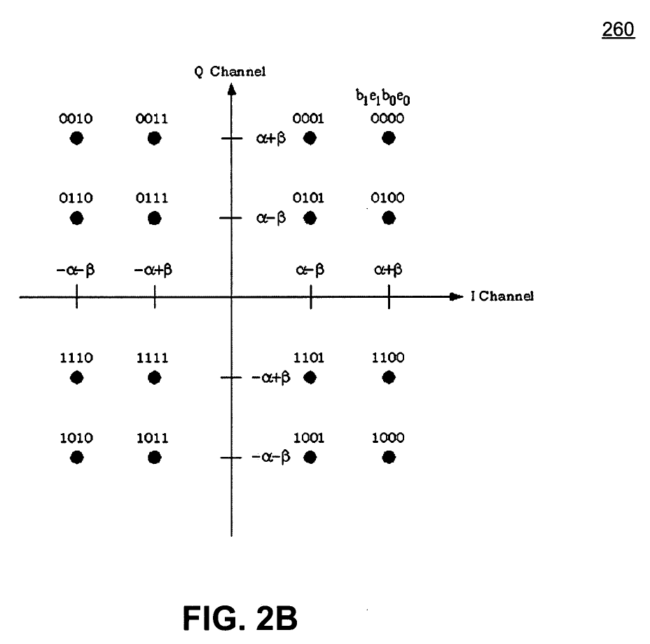

FIG. 2A is a constellation diagram 200 of an embodiment of a layered modulation implementation. As an example, the wireless communication system 100 of FIG. 1 may implement layered modulation in the manner shown in FIG. 2A. The layered modulation implementation can be referred to as Quadrature Phase Shift Keying (QPSK) on QPSK. The implementation includes a QPSK modulated base layer. Although a QPSK on QPSK layered modulation implementation is illustrated in FIG. 2A, the decoder apparatus and methods disclosed herein are not limited to any particular type of layered modulation. For example, other layered modulation embodiments may use 16-QAM over QPSK, or some other form of layered modulation.

The QPSK base layer is defined by four points 202a-202d. However, as described later, the points do not need to correspond to actual constellation points in the layered modulation. The enhancement layer is also QPSK modulated. The QPSK modulated enhancement layer occurs on top of the QPSK base layer constellation. The QPSK constellation for the enhancement layer includes four positions, but the constellation can be centered about any of the four constellation points 202a-202d of the base layer.

As an example, a base layer point 202b occurs in the second quadrant, where the in-phase (I) signal component is negative and the quadrature (Q) signal component is positive. On top of the base layer point 202b are four constellation points 210a-210d of the enhancement layer. Similarly, each quadrant, corresponding to a point 202a-202d of the base layer, has four constellation points of the enhancement layer.

The base and enhancement layer data can be mapped to a constellation point based on a predetermined map or algorithm. For example, the base layer data and enhancement layer data can each include two bits per symbol, such that the combination of the base layer and enhancement layer data is four bits. The mapping operation can take the four bits and map them to a constellation point from a predetermined constellation, such as a 16-QAM constellation or a QPSK on QPSK constellation.

FIG. 2B is a constellation diagram 260 of an embodiment of a particular layered modulation implementation. The constellation diagram 260 of FIG. 2B is substantially a 16-QAM constellation in which the base layer data maps to a particular quadrant of the constellation, and the enhancement layer data maps to the particular position within the constellation. The 16-QAM constellation 260 does not need to be consistently spaced, but may be modified to have a consistent spacing within each quadrant and a distinct spacing between the nearest points within different quadrants. Furthermore, some of the points in the constellation may be mirrored with respect to a midpoint in the quadrant.

The input to a signal mapping block includes 2 bits from the base layer (b₁ b₀) and 2 bits from the enhancement layer (e₁ e₀). The base layer stream is transmitted at a higher power level with respect to the enhancement layer stream and the energy ratio r satisfies the following relationship:

$$r = \frac{{α}^{2}}{{β}^{2}} .$$

By normalizing the average constellation point energy (=2α²+2β²) to 1, α and β can be expressed in terms of energy ratio r as

$$α = \sqrt{\frac{r}{2 ( 1 + r )}}$$

$$β = \sqrt{\frac{1}{2 ( 1 + r )}}$$

The same energy ratio can be used for multiple tones in the same logical channel of an OFDM system, where a logical channel can include one or more tones from the OFDM group of tones. However, the energy ratio can change from logical channel to logical channel. Therefore, the signal mapping block can map the same data to different constellations depending on the energy ratio, with the constellation determined by the energy ration. Thus, an OFDM symbol can include multiple logical channels. The tones of a particular logical channel can have a different energy ratio relative to tones corresponding to another logical channel in the same OFDM symbol.

For example, a signal mapping block can be configured to map base and enhancement layer data to one of two constellation, where the two constellations correspond to energy ratios of 4 and 9. Note, the layered modulation signal constellation follows the Gray mapping, and the signal constellation for layered modulation is equivalent to the signal constellation of 16-QAM when the energy ratio, r, is equal to 4.

In other embodiments, the signal constellation for layered modulation is a simple addition of two scaled QPSK signal constellation. Such a simple additions of QPSK constellations does not follow a Gray mapping rule as does the constellation shown in FIG. 2B. A signal constellation that does not follow Gray mapping may provide reduced performance compared to a constellation conforming to Gray mapping.

The underlying data defining the respective quadrants of the base and enhancement layers can be encoded using one or more encoding processes. The encoding process used can be any encoding process, and the type of encoding is not a limitation on the decoding apparatus and methods disclosed herein, except where the decoder is specific to a particular encoder. The encoder can include, for example, a convolutional encoder, a turbo encoder, a block encoder, an interleaver, a CRC encoder, a combination of encoders, and the like, or some other process or apparatus for encoding data.

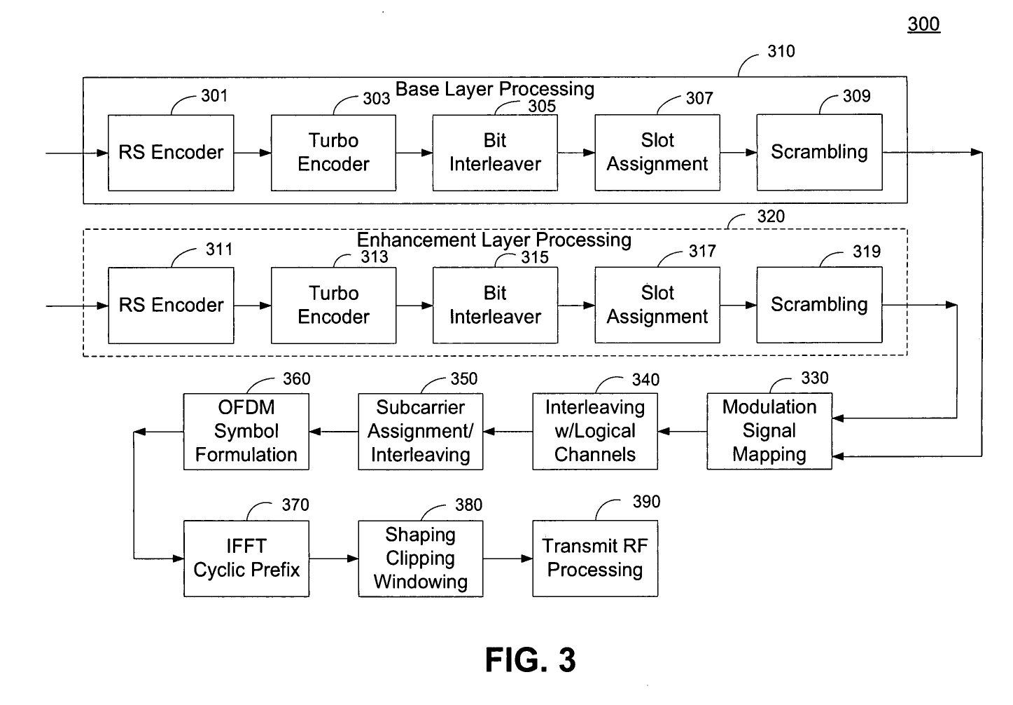

FIG. 3 is a functional block diagram of an embodiment of a transmitter 300 configured for a layered modulation system. In one embodiment, the transmitter 300 can be implemented in the broadcast transmitter of the system of FIG. 1. The transmitter 300 of FIG. 3 can be configured for layered modulation in an Orthogonal Frequency Division Multiple Access (OFDMA) or Orthogonal Frequency Division Multiplex (OFDM) system using the constellation of FIG. 2B. However, the transmitter 300 shown in FIG. 3 represents an embodiment and is not a limitation on the disclosed decoder apparatus and methods. For example, a single carrier system can be modulated with layered modulation data, and the corresponding decoder in a receiver can be configured to operate on a single carrier with layered modulation.

The transmitter 300 can include substantially similar base layer and enhancement layer processing blocks, 310 and 320, respectively. The base layer processing block 310 can be configured to process base layer data into a desired modulation format, for example QPSK. The enhancement layer processing block 320 can be similarly configured to process enhancement layer data into a desired modulation format, for example QPSK.

The base layer processing block 310 and the enhancement layer processing block 320 receive the respective data from a source encoder (not shown), which can be the broadcast media source of FIG. 1. In one embodiment, the base layer data and the enhancement layer data can include video signals, audio signals, or some combination of video and audio signals. The video/audio signal in the base layer corresponds to the data required to reproduce basic quality of service at the receiver. The video/audio signal in the enhancement layer corresponds to the additional data required to generate more enhanced quality of service at the receiver. Hence, users capable of decoding two layers (base layer and enhancement layer) can enjoy fully enhanced quality of video/audio signal while users capable of decoding the base layer can get a minimum quality of video/audio signal.

Within each of the base layer processing block 310 and the enhancement layer processing block 320, the data is coupled to a Reed Solomon encoder 301 or 311 for block coding. The output of the Reed Solomon encoders 301 and 311 are coupled to respective turbo encoders 303 and 313. The turbo encoders 303 and 313 can be configured to turbo encode the data according to a predetermined encoding rate. The encoding rate can be fixed or selectable from a plurality of encoder rates. For example, the turbo encoders 303 and 313 can independently be configured to provide a coding rate of 1/3, 1/2, or 2/3.

The turbo encoder 303 and 313 outputs are coupled to respective bit interleavers 305 and 315 to improve resistance to burst errors. The output of the bit interleavers 305 and 315 are coupled to respective slot assignment modules 307 and 317. The slot assignment modules 307 and 317 can be configured to time align the encoded symbols with a predetermined time slot, such as an interleaving time slot in a time division multiplexed system. The outputs of the slot alignment modules 307 and 317 are coupled to respective scramblers 309 and 319. The output of the scramblers 309 and 319 represent the encoded base layer and enhancement layer symbols.

The symbols from the two layers are combined at a signal mapping block 330. The signal mapping block 330 can be configured to map the base and enhancement layer symbols to a particular point in the constellation for the layered modulation. For example, the signal mapping block 330 can be configured to map one or more base layer symbols along with one or more enhancement layer symbols to a single point in the layered modulation constellation. The signal mapping block 330 can be configured to map each logical channel to a constellation having a predetermined energy ratio. However, different logical channels can be mapped to constellations having different energy ratios.

The output of the signal mapping block 330 is coupled to a time interleaver 340 that is configured to interleave the mapped constellation point to a particular logical channel. As described earlier, the system may implement a time division multiplex configuration where a single logical channel is time multiplexed with a plurality of other logical channels. The aggregate of logical channels can be time interleaved, or otherwise time multiplexed, using a predetermined time multiplex algorithm, such as a round robin assignment.

The output of the time interleaver 340 is coupled to a subcarrier assignment module 350. The subcarrier assignment module can be configured to assign one or more tones, frequencies, or subcarriers from an OFDM tone set to each set of time interleaved logical channels. The subset of subcarriers assigned to a set of time interleaved logical channels can range from one channel to a plurality of subcarriers up to all available subcarriers. The subcarrier assignment module 350 can map a serial time interleaved set of logical channels to a subset of subcarriers according to a predetermined algorithm. The predetermined algorithm can be configured to assign the logical channels in a persistent manner, or can be configured to assign subcarriers according to a frequency hopping algorithm.

The output of the subcarrier assignment module 350 is coupled to an OFDM symbol module 360 that is configured to modulate the subcarriers based on the assigned layered modulation symbol. The modulated OFDM subcarriers from the OFDM symbol module 360 are coupled to an IFFT module 370 that can be configured to generate an OFDM symbol and append or prepend a cyclic prefix or a predetermined length.

The OFDM symbols from the IFFT module 370 are coupled to a shaping block 380 where the OFDM symbols can be shaped, clipped, windowed, or otherwise processed. The output of the shaping block 380 is coupled to a transmit RF processor 390 for conversion to a desired operating frequency band for transmission. For example, the output of the transmit RF processor 390 can include or be coupled to an antenna (not shown) for wireless transmission.

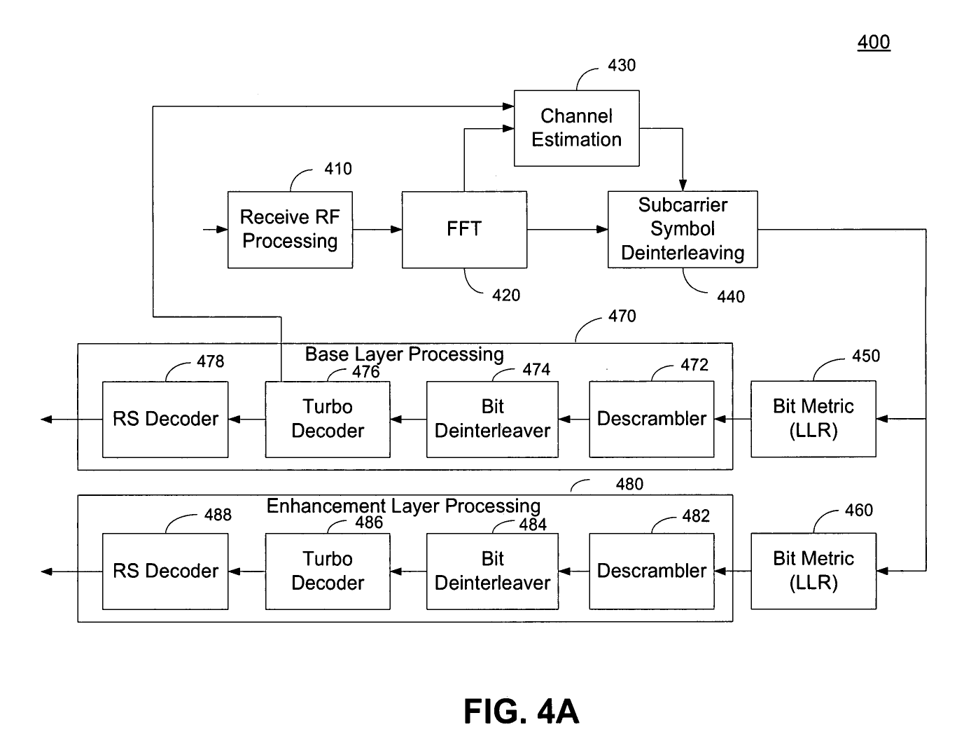

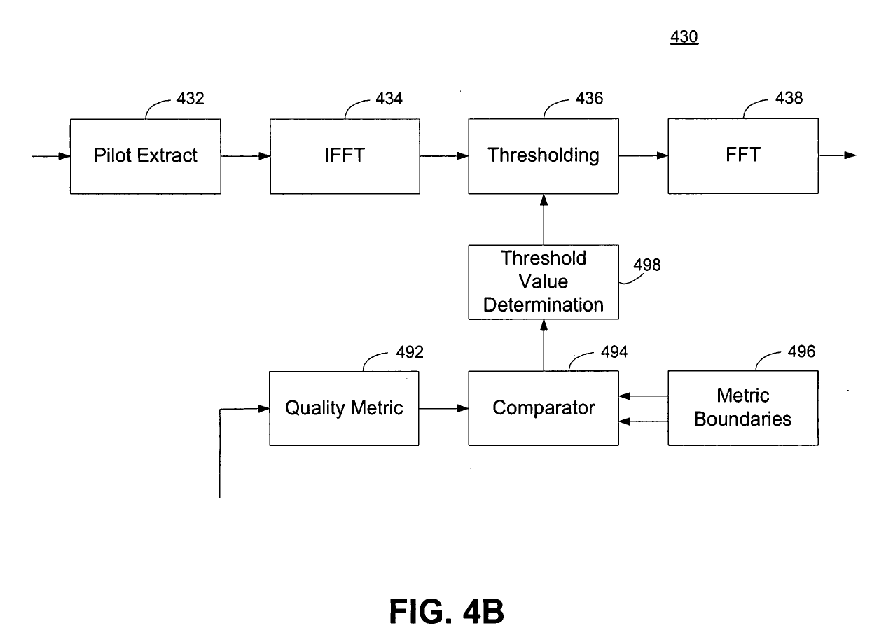

FIG. 4A is a functional block diagram of a receiver 400 configured to decode the layered modulation data generated by the transmitter of FIG. 3. In one embodiment, the receiver 400 can be implemented in the user terminal of the system of FIG. 1.

The receiver 400 includes a receive RF processor configured to receive the transmitted RF OFDM symbols, process them and frequency convert them to baseband OFDM symbols or substantially baseband signals. A signal can be referred to as substantially a baseband signal if the frequency offset from a baseband signal is a fraction of the signal bandwidth, or if signal is at a sufficiently low intermediate frequency to allow direct processing of the signal without further frequency conversion. The OFDM symbols from the receive RF processor 410 are coupled to an FFT module 420 that is configured to transform the OFDM symbols to the layered modulation frequency domain subcarriers.

The FFT module 420 can be configured to couple one or more subcarriers, such as predetermined pilot subcarriers, to a channel estimator 430. The pilot subcarriers can be, for example, one or more equally spaced sets of OFDM subcarriers.

The channel estimator 430 is configured to use the pilot subcarriers to estimate the various channels that have an effect on the received OFDM symbols. In one embodiment, the channel estimator 430 can be configured to determine a channel estimate corresponding to each of the subcarriers. The channel estimates at a particular subcarrier can be used as a channel estimate for adjacent subcarriers, for example, those subcarriers within a predetermined coherence bandwidth of the pilot subcarrier.

The channel estimator 430 can be configured to determine a channel estimate that is used for a plurality of layered modulation signal decoders. For example, the channel estimator 430 can be configured to determine a channel estimate for each of the subcarriers corresponding to the pilot subcarriers, and the channel estimate can be used in both a base layer decoder and an enhancement layer decoder.

The received signal quality to achieve a particular quality of service varies based on the signal layer. In layered modulation systems the operating signal to noise ratio (SNR), which provides a packet error rate of approximately 0.01, is different for each layer. For a layered modulation signal constellation having an energy ratio of 4, the difference is about 5 dB between the SNR value needed to obtain a PER of 0.01 in the base layer and the enhancement layer. For an energy ratio of 9, the SNR difference between the base layer and the enhancement layer is about 10 dB. To adapt for this difference in the operating SNR, the channel estimator 430 can adapt the channel estimation threshold value. In one embodiment, the channel estimation threshold value can be varied by varying a scaling parameter that multiplies a received signal energy after Automatic Gain Control (AGC). The scaling parameter may also be referred to as a threshold coefficient.

Suppose that after AGC, the energy is normalized to one. Then Es+No is equivalent to 1, where Es is the transmit signal energy and No is the noise variance. If the SNR is 0 dB, then Es=0.5 and No=0.5. If the SNR is 10 dB, then Es=0.909 and No=0.091. If the channel estimator 430 is configured to use a fixed threshold coefficient of 2; and the energy after AGC is normalized to 1, the threshold value is 2*1=2. For the SNR of 0 dB, the threshold value is approximately 4 times of the noise variance (2=4*0.5) and for the SNR of 10 dB, the threshold is approximately 22 times the noise variance (2=22*0.091). As the operating SNR increases, it is expected that threshold value over noise variance should increase since the receiver can be more aggressive in thresholding channel estimates.

The channel estimator 430 can be configured to initially use a nominal channel estimation threshold based on the energy ratio of the received signal, and can be configured to vary, modify, or otherwise adapt the channel estimation threshold based at least in part on the received signal.

In one embodiment, the channel estimator 430 is configured to vary the channel estimation threshold value based in part on a quality of service or parameter related to quality of service. For example, the channel estimator 430 can be configured to vary the channel estimation threshold based on a received Symbol Error Rate (SER), Packet Error Rate (PER), Bit Error Rate (BER), or other metric. In another embodiment, the channel estimator can be configured to vary the channel estimation threshold value based on a parameter related to a quality of service. For example, the channel estimator 430 can be configured to vary the channel estimation threshold value based in part on a SNR, Energy Estimate, or some other received signal metric.

The channel estimator 430 can vary the channel estimation threshold value based on metrics determined from the base layer decoder, enhancement layer decoder, or a combination of base layer and enhancement layer decoders. The channel estimator 430 can be configured to select the channel estimation threshold value from a plurality of threshold values, or can be configured to determine the channel estimation threshold value by incrementally changing the previous threshold value. Additionally, the channel estimator 430 can be configured to vary the channel estimation threshold directly, or can vary some related parameter, such as a scale factor or threshold coefficient.

In the receiver 400 embodiment of FIG. 4A, the channel estimator 430 is configured to receive a quality of service metric from the base layer processor 470, and more particularly, from the turbo decoder 476 in the base layer processor 470. The channel estimator 430 can be configured to receive the energy estimate determined by the base layer turbo decoder 476.

The subcarriers from the FFT module 420 and the channel estimates are coupled to a subcarrier symbol deinterleaver 440. The symbol deinterleaver 440 can be configured to reverse the symbol mapping performed by the subcarrier assignment module of FIG. 3.

The receiver 400 is configured to perform base layer decoding and enhancement layer decoding on each OFDM subcarrier or tone. FIG. 4A illustrates a single base layer decoder and enhancement layer decoder for the sake of clarity and brevity.

The base layer decoder and enhancement layer decoder can operate substantially in parallel. Each of the decoder modules can be configured to operate concurrently on the same received constellation points. The enhancement layer decoder can thus operate substantially independently of the base layer decoder and does not rely on the results of the base layer decoder when decoding the enhancement layer data. The base layer decoder and enhancement layer decoders can be considered to operate substantially independently even though the decoders share some sub-modules, provided the enhancement layer decoder does not rely on the decoding results obtained from the base layer decoder. Thus, the base layer decoder and enhancement layer decoder can share channel estimates, and can even share a single bit metric module, for example 450. Yet, the decoders can be considered substantially independent if the enhancement layer decoder does not rely on the results of the base layer decoder when decoding the enhancement layer data.

The decoders illustrated in the receiver 400 embodiment of FIG. 4A are configured to decode turbo encoded layered modulation data. Of course, if the transmitter is configured to generate some other type of encoding, the decoders in the receiver 400 would be matched to the encoder type. For example, the transmitter can be configured to encode the data using turbo coding, convolutional coding, Low Density Parity Check (LDPC) coding, or some other encoding type. In such an embodiment, the receiver 400 is configured with the complementary decoders. Thus, each of the base layer decoders and enhancement layer decoders in the receiver 400 can be configured to provide turbo decoding, convolutional decoding, such as using Viterbi decoding, LDPC decoding, or some other decoder or combination of decoders.

Each of the layered modulation tones is coupled to a base layer bit metric module 450 and an enhancement layer bit metric module 460. The bit metric modules 450 and 460 can operate on the layered modulation tone to determine a metric indicative of the quality of the received constellation point.

In one embodiment, where the symbols represented in the constellation point are turbo coded, the bit metric modules 450 and 460 can be configured to determine a log likelihood ratio (LLR) of the received symbols represented by the constellation point. The LLR is the logarithm of the likelihood ratio. The ratio can be defined as the probability that the original bit is 1 over the probability that the original bit is equal to 0. Alternatively, the ratio can be defined in a reverse way, where the LLR is the probability that the original bit is 0 over the probability that the original bit is equal to 1. There is no substantial difference between these two definitions. The bit metric modules 450 and 460 can use, for example, the constellation point magnitudes and the channel estimate to determine the LLR values.

Each bit metric module 450 and 460 utilizes a channel estimate and a received signal to determine a LLR value. A noise estimate may also be used. However, the noise estimate term can be substantially ignored if a turbo decoding method that provides the same results regardless of the noise estimate is used. In such an embodiment, the bit metric modules 450 and 460 hardware can use a predetermined value as the noise estimate in calculating LLR values.

The output of the base bit metric module 450 is coupled to a base layer processor 470. The output of the enhancement layer bit metric module 460 is coupled to an enhancement layer processor 480 that functionally, operates similarly to the base layer processor 470. For example, the LLR values are coupled from the bit metric modules 450 and 460 to the respective base layer or enhancement layer processors 470 and 480.

The base layer processor 470 includes a descrambler 472 configured to operate on the received LLR values to reverse the symbol scrambling performed in the encoder. The output of the symbol descrambler 472 is coupled to a bit interleaver 474 that is configured to deinterleave the previously interleaved symbols. The output of the bit deinterleaver 474 is coupled to a turbo decoder 476 that is configured to decode turbo encoded symbols according to the coding rate used by the turbo encoder. For example, the turbo decoder 476 can be configured to perform decoding of rate 1/3, 1/2, or 2/3 turbo encoded data. The turbo encoder 476 operates, for example, on the LLR values. The decoded outputs from the turbo decoder 476 is coupled to a Reed Solomon decoder 478 that can be configured to recover the base layer bits based in part on the Reed Solomon encoded bits. The resulting base layer bits are transferred to a source decoder (not shown).

The enhancement layer processor 480 operates similar to the base layer processor 470. A descrambler 482 receives the LLR values from the enhancement bit metric module 460. The output is coupled to a bit deinterleaver 484 and the turbo decoder 486. The output of the turbo decoder 486 is coupled to the Reed Solomon decoder 488. The resulting enhancement layer bits are transferred to a source decoder (not shown).

The exact expression for the LLR is given by:

$${LLR}_{i} = log \frac{{\sum }_{x : {x}_{i} = 0} exp ( - {\vert y - hx \vert}^{2} / {N}_{0} )}{{\sum }_{x : {x}_{i} = 1} exp ( - {\vert y - hx \vert}^{2} / {N}_{0} )} .$$

In the equation, LLRᵢ is the LLR of the i'th bit encoded by the modulation symbol and xᵢ denotes the i'th bit of the constellation point x. The value y represents the received symbol, h represents the channel estimate, and N₀ represents the noise estimate. Computing the exact solution is generally too complicated or processing intensive to be implemented in practice.

An approximation can be determined as the maximum of the variables. For QPSK this approximation in fact corresponds to the exact LLR expression. If we use this approximation, the following result holds;

$${LLR}_{i} = \frac{2 Re \{ h ( b - a ) {y}^{*} \}}{{N}_{0}} + \frac{{hh}^{*}}{{N}_{0}} ( {aa}^{*} - {bb}^{*} ) .$$

Here, b is the closest 0 bit point in the constellation and a is the closest 1 bit point in the constellation. The equation can be simplified furthermore once a specific modulation scheme is determined.

FIG. 4B is a simplified functional block diagram of a channel estimator 430, such as the channel estimator shown in the receiver of FIG. 4A. The channel estimator 430 can e configured to determine a channel estimate corresponding to each of a plurality of pilot subcarriers in an OFDM system. The channel estimator 430 can be configured to vary the channel estimation threshold used in determining the channel estimates, and can vary the channel estimation threshold value for each channel estimate independently of any other channel estimate. For example, the channel estimator 430 can be configured to vary a channel estimate within predefined limits that are based on the energy ratio of the received layered modulation signal.

The channel estimator 430 includes a pilot extraction module 432 coupled to an IFFT 434. The output of the IFFT 434 is coupled to a thresholding module 436, and the output of the thresholding module 436 is coupled to a FFT 438 that outputs the subcarrier channel estimates.

The pilot extraction module 432 is coupled to the FFT module 420 in the receiver. The pilot extraction module 432 can extract those OFDM subcarriers corresponding to pilot channels. The output of the pilot extraction module 432 can be the pilot subcarriers of the received OFDM symbol.

The IFFT 434 transforms the pilot subcarriers to time domain channel estimate components. The time domain components may also be referred to as samples or taps. The time domain channel estimate taps are coupled to the thresholding module 436 where each time domain tap can be compared against a channel estimation threshold value. In one embodiment, the thresholding module 436 is configured to determine an average energy of the channel time domain taps by summing all of the taps and dividing by the number of taps. The thresholding module 436 can then determine a channel estimate threshold value by scaling the average energy by a threshold coefficient. The channel estimate taps that fall below the channel estimate threshold can be set to a predetermined value. The predetermined value can be, for example, zero or some other substantially insignificant value.

The channel estimate taps that are filtered by the thresholding module 436 are coupled to the FFT 438. The FFT 438 transforms the filtered time domain taps to the subcarrier channel estimates.

The channel estimator 430 is configured to adjust or otherwise vary the channel estimation threshold used by the thresholding module 436. The channel estimator 430 can include a quality metric module 492 configured to receive a received signal quality parameter from one or more of the layered modulation processors. The quality metric module 492 can determine a quality of service or some other signal quality metric based on the signal quality parameter. The output of the quality metric 492 is coupled to a comparator 494.

A metric boundary module 496 is configured to present one or more boundary values to the comparator 494. The comparator 494 compares the output of the quality metric module 492 to the metric boundaries. The output of the comparator 494 is coupled to a threshold determination module 498 that is configured to determine the channel estimation threshold or a value, such as the threshold coefficient, that is used by the thresholding module 436 when performing channel estimate thresholding.

For example, the quality metric module 492 can be configured to receive a SNR or energy estimate from one or more of the base layer processor and enhancement layer processor. In one embodiment, the quality metric module 492 can be configured to receive the energy estimate from the base layer turbo decoder.

The quality metric module 492 can be configured, for example, to determine or estimate a quality of service or some other parameter based on the energy estimate. In one embodiment, the quality metric module 492 is configured to estimate a packet error rate, a symbol error rate, a bit error rate, or some other quality of service metric based on the energy estimate.

The comparator 494 compares the quality of service value received from the quality metric module 492 against one or more boundary values or thresholds received from the metric boundary module 496. In one embodiment, the metric boundary module 496 includes a memory configured to store one or more boundary values. The boundary values can represent, for example, lower and upper boundaries on the quality of service metric. The metric boundary module 496 can store, for example, boundary values that are based on a signal energy ratio.

The threshold value determination module 496 can be determined to set the value of the channel estimation threshold or a parameter that is used to determine the channel estimation threshold value. In one embodiment, the threshold value determination module determines a threshold coefficient.

The threshold value determination module 498 can, for example, start with the threshold coefficient optimized for the base layer. The threshold value determination module 498 can change the threshold coefficient to a value optimized for the enhancement layer if the quality metric exceeds the lower boundary. If the quality metric does not exceed the lower boundary, the threshold value determination module 498 can set the threshold coefficient to a value optimized for the base layer.

If the threshold coefficient is already at the value optimized for the enhancement layer, the threshold value determination module 498 can set the threshold coefficient to a value optimized for the base layer if the threshold value is less than an upper boundary. The threshold value determination module 498 can allow the threshold coefficient to remain at the value optimized for the enhancement layer if the threshold value is less than an upper boundary.

In another embodiment, the threshold value determination module 498 can increment or decrement the threshold coefficient by a predetermined value. The predetermined value may or may not have any relation to the optimal threshold coefficients.

In a particular embodiment, the channel estimator 430 is configured to adapt a channel estimation threshold value by obtaining the energy estimate for the base layer from the base layer turbo decoder. Based on this estimate, the quality metric 492 determines an uncoded SER (symbol error rate) of the base layer.

The channel estimator 430, via the threshold value determination module 498 initially sets the threshold coefficient optimal for the base layer. The quality metric module 492 receives the energy estimate from the turbo decoder of the base layer.

The quality metric is compared against predetermined boundary values. If this estimate is larger than a lower boundary, the threshold value determination module 498 changes the threshold coefficient to the value optimized for the enhancement layer. If this estimate is not larger than the lower boundary, then do not change the threshold. The channel estimator repeats the initial comparison after waiting a predetermined number of OFDM symbols while the threshold coefficient is optimized for the base layer.

If the threshold coefficient is changed to the value optimized for the enhancement layer, the quality metric module receives an energy estimate from the turbo decoder of the base layer after a predetermined number of OFDM symbols. If this estimate is smaller than the upper boundary, the threshold value determination module 498 changes the threshold back to the value optimized for the base layer. The channel estimator then resumes processing as described above for conditions where the value is optimized for the base layer. If this estimate is larger than the upper boundary, do not change the threshold and repeat processing with the threshold set to the enhancement layer. The steps are summarized below.

A. Set the threshold coefficient optimal for the base layer.

B. Measure the energy estimate from the turbo decoder of the base layer.

C. If this estimate is larger than the lower boundary, change the threshold coefficient to the value optimized for the enhancement layer. If this estimate is not larger than the lower boundary, do not change the threshold and return to B after waiting a predetermined number of OFDM symbols.

D. Measure the energy estimate from the turbo decoder of the base layer after the predetermined number of OFDM symbols.

E. If this estimate is smaller than the upper boundary, change the threshold to the value optimized for the base layer, and return to B. If this estimate is larger than the upper boundary, then do not change the threshold and return to D.

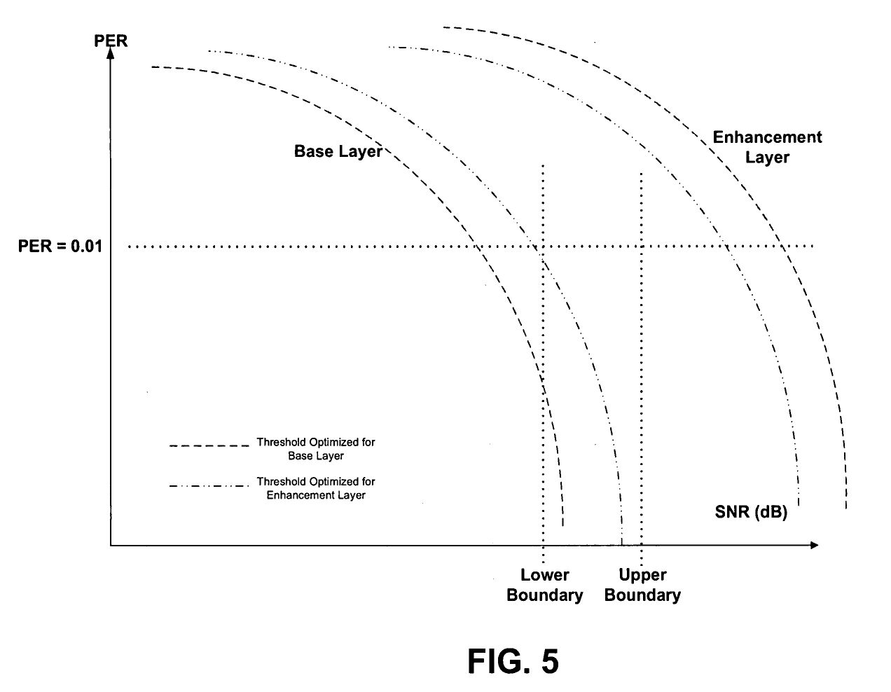

FIG. 5 is a graph of the boundary values and the corresponding signal quality metric. The SNR values for the boundary values are shown on the horizontal axis and the corresponding PER are shown on the vertical axis.

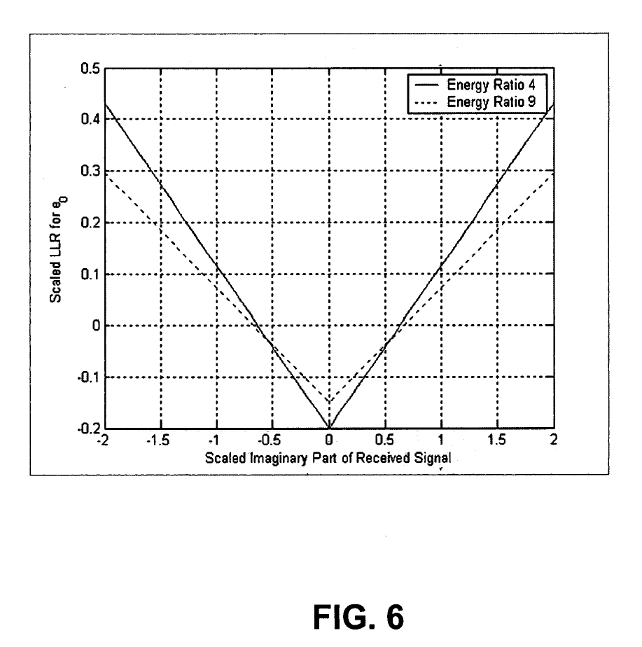

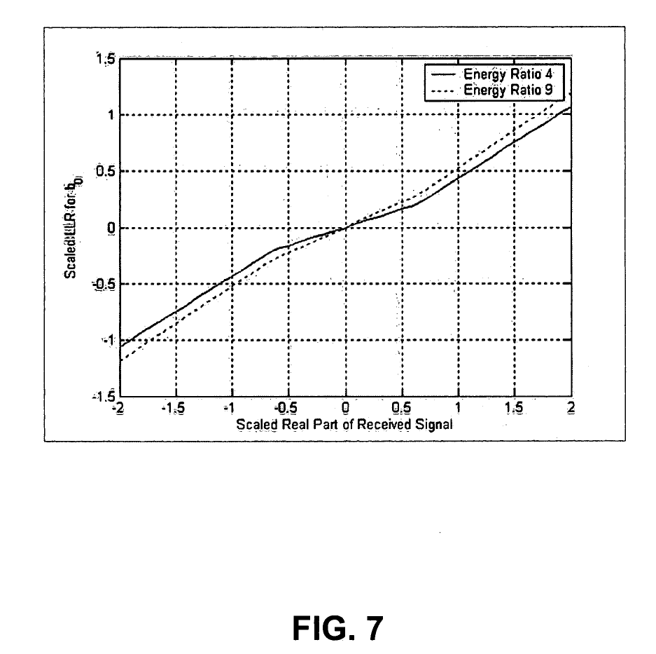

FIGS. 6 and 7 provide plots of the LLR for the base layer and enhancement layer data when modulated using the constellation shown in FIG. 2B. FIG. 5 shows the LLR for the e₀ bit of the enhancement layer. However, the plot for the LLR for the e₁ bit of the enhancement layer is substantially the same, with the horizontal axis changed to refer to the Real part of the received signal. Similarly, FIG. 6 shows the LLR for the b₀ bit of the base layer. However, the plot for the LLR for the b₁ bit of the base layer is substantially the same, with the horizontal axis changed to refer to the Imaginary part of the received signal.

In the LLR calculation block the LLR value depends on a channel estimate from the channel estimation block. The performance of each layer depends on a threshold value being used in the channel estimation block. The channel estimation threshold value represents a value over which the channel estimate is used. That is, if the channel estimate exceeds the threshold value, the actual channel estimate is used. Conversely, if the channel estimate is less than the threshold value, the channel estimate is assigned a predetermined value, which can be, for example, zero or some other sufficiently small value. If the channel estimate is equal to the threshold value, the receiver can be configured to use the actual channel estimate or use the predetermined value. Either option is practical, provided the decision is executed consistently.

The channel estimation module in the receiver estimates the channel for each tone in a multiple channel system, such as an OFDM system. Thus, the channel estimation module or each bit metric module can compare the channel estimate to the threshold. It may be advantageous to perform the comparison of the channel estimate to the threshold at the channel estimation module.

In one embodiment, the channel estimation module can be configured to separate the pilot tones used in channel estimation from the output of the FFT module. The channel estimation module can then transform the pilot samples to a time domain channel estimate using, for example, an Inverse FFT (IFFT). Each of the time domain taps represents a component of a channel estimate. The channel estimation module can then filter the individual time domain samples or taps based on the channel estimation threshold value. The channel estimation module can compare a magnitude of each actual time domain tap to the channel estimation threshold. The channel estimation module can select one of the actual time domain tap or a predetermined value based on the comparison. Once the channel estimation module processes the time domain taps based on the channel estimation threshold value, the channel estimation module can transform the processed time domain samples or taps back to frequency domain channel estimates. For example, the channel estimation module can Fourier transform the processed time domain taps to generate the frequency domain channel estimates.

The channel estimation threshold value was optimized using simulations for the following two channel models; Repeated International Telecommunications Union (ITU) Pedestrian B (PEDB) model with 120 km/hr and Repeated Advanced Television Systems Committee (ATSC) model with 20 km/hr.

Table 1 shows an example of optimal threshold for the base layer and Table 2 shows the optimal threshold value for the enhancement layer. When the turbo code rate is 2/3, the enhancement layer cannot achieve Packet Error Rate (PER) of 0.01 due to a RF noise floor and Inter-Chip-Interference (ICI) from Doppler speed. The scalar threshold value shown in the tables refers to a scalar multiplier that is applied to a normalized channel estimate value to achieve the channel estimation threshold. For example, the normalized channel estimate value can be an average of the time domain taps derived from the pilot tones.

TABLE 1
Optimal threshold coefficient value for the Base Layer

| | Turbo | Turbo | Turbo |
|---|---|---|---|
| | Rate = ⅓ | Rate = ½ | Rate = ⅔ |
| Ratio 4, PEDB Rep. | 2 or 3 | 1 or 1.5 | 0.5 |
| (120 km/hr) | | | |
| Ratio 4, ATSC Rep. (20 km/hr) | 2 or 3 | 1 or 1.5 | 0.5 or 1 |
| Ratio 9, PEDB Rep. | 2 or 3 | 1 or 1.5 | 1 |
| (120 km/hr) | | | |
| Ratio 9, ATSC Rep. | 2 or 3 | 1.5 | 1 |
| (20 km/hr) | | | |

TABLE 2
Optimal threshold coefficient value for the Enhancement Layer

| | Turbo | Turbo | Turbo |
|---|---|---|---|
| | Rate = ⅓ | Rate = ½ | Rate = ⅔ |
| Ratio 4, PEDB Rep. | 1 | 0.5 | 0.25 |
| (120 km/hr) | | | |
| Ratio 4, ATSC Rep. | 1 | 0.5 | 0.25 |
| (20 km/hr) | | | |
| Ratio 9, PEDB Rep. | 0.5 (The value 1 will | 0.25 | NA |
| (120 km/hr) | give 0.3 dB loss.) | | |
| Ratio 9, ATSC Rep. | 1 | 0.25 | NA |
| (20 km/hr) | | | |

These two tables show that the optimal threshold value, which is proportional to the threshold coefficient value, is almost constant over channel models, but depends on the layer, the code rate, and the energy ratio between two layers. From an implementation viewpoint, the receiver structure can be simplified by using the same threshold value for both layers. The use of the same threshold value may result in some signal degradation over using separate optimized threshold values. One embodiment targets less than a 0.5 dB loss (degradation) in order to eliminate need to have two separate threshold values. Table 3 shows this result of a single threshold value.

TABLE 3
Threshold value for both layers, allowing 0.5 dB loss

| | Turbo | Turbo | Turbo |
|---|---|---|---|
| | Rate = ⅓ | Rate = ½ | Rate = ⅔ |
| Ratio 4, PEDB Rep. | 2 | 1 | 0.25 |
| (120 km/hr) | | | |
| Ratio 4, ATSC Rep. | 2 | 1 | 0.25 |
| (20 km/hr) | | | |
| Ratio 9, PEDB Rep. | Impossible (1 if | Impossible (0.5 if | 1 (the |
| (120 km/hr) | 1 dB loss | 1 dB loss | enhancement |
| | is allowed.) | is allowed.) | layer NA) |
| Ratio 9, ATSC Rep. | 1 | 0.5 | 1 (the |
| (20 km/hr) | | | enhancement |
| | | | layer NA) |

This table shows that for energy ratio 4, it is possible to have the same threshold values for both layers if we allow them to endure 0.5 dB performance loss. However, for energy ratio 9, it is impossible. For ATSC channel, which is less frequency selective than PEDB channel, it is possible to have the same threshold value within 0.5 dB loss. However, for PEDB channel, it is impossible to have the same threshold. If we allow 1 dB performance loss, then it is possible to use the same threshold for energy ratio 9 as well.

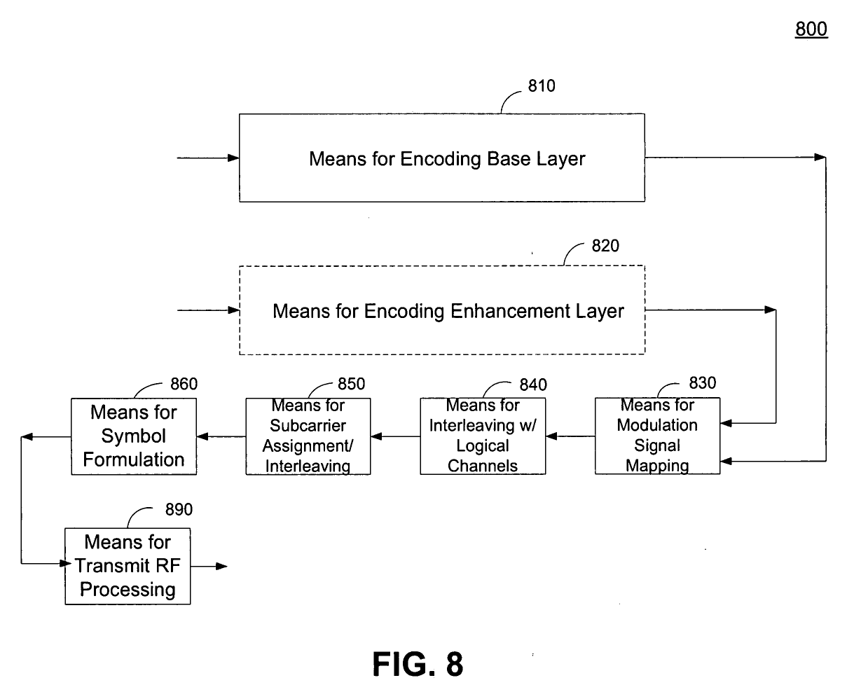

FIG. 8 is a simplified functional block diagram of an embodiment of a transmitter configured for a layered coded modulation system. FIG. 8 is a simplified functional block diagram of an embodiment of a transmitter 800 in a layered coded modulation system. The transmitter 800 can be the transmitter in the system of FIG. 1.

The transmitter 800 includes means for encoding a base layer 810 and independent means for encoding an enhancement layer 820. The means for encoding the base layer 810 and means for encoding the enhancement layer 820 can each include various means for encoding a signal including, but not limited to, means for block encoding, means for turbo encoding, means for interleaving, means for scrambling, and other means for encoding.

The means for encoding the base layer 810 and the means for encoding the enhancement layer 820 are coupled to a means for modulating and mapping the encoded symbols 830. The means for modulation signal mapping 830, also referred to as a means for mapping signals, is configured to map the encoded symbols to a layered modulation constellation point. The means for mapping signals 830 can be configured to map the encoded symbols to a constellation having an energy ratio selected from a plurality of energy ratios.

The transmitter couples the mapped signals to a means for interleaving 840 configured to interleave the mapped constellation point with other signal interleaves assigned to the same logical channel. The output of the means for interleaving 840 is coupled to a means for subcarrier assignment 850 configured to map the logical channels to physical channels. The physical channels can include one or more subcarriers and the means for subcarrier assignment 850 can be configured to modulate the subcarrier with an appropriate constellation point using a means for modulating a subcarrier.

The means for subcarrier assignment 850 can also be configured to interleave the physical channels assigned to a plurality of logical channels. Each of the physical channels can be modulated with a constellation having a different energy ratio.

The output of the means for subcarrier assignment 850 is coupled to a means for symbol formulation 860 that can be configured to generate an OFDM symbol from the combination of subcarriers. The output of the means for symbol formulation 860 is coupled to a means for transmit processing 890 for translation to an operating frequency for wireless transmission.

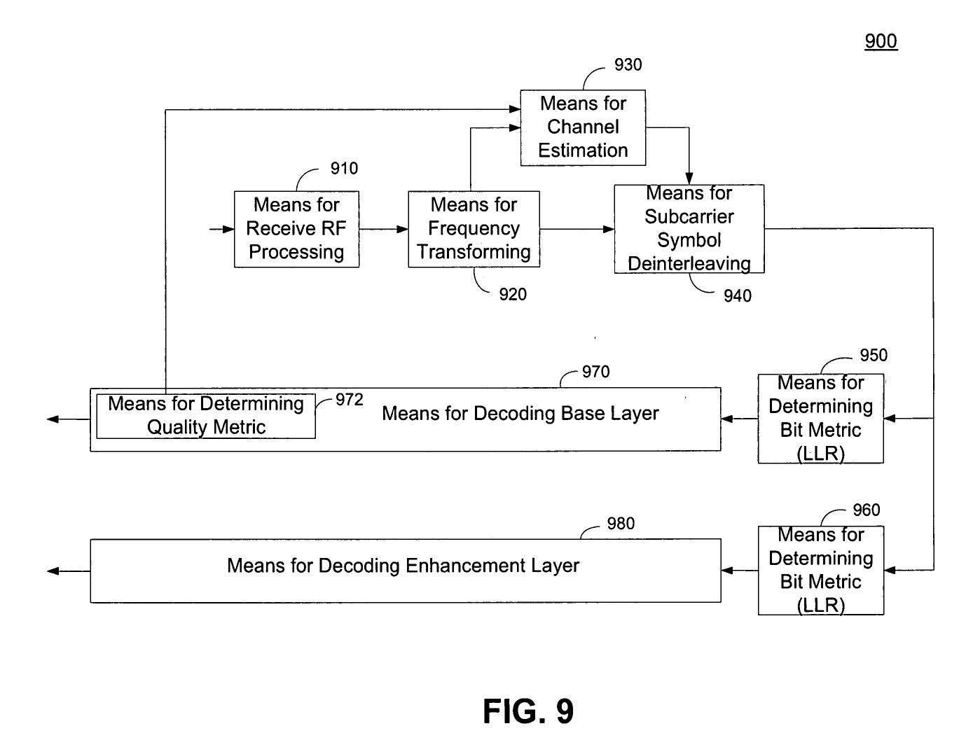

FIG. 9 is a simplified functional block diagram of an embodiment of a receiver 900 configured for operation in a layered modulation system. The receiver 900 can be, for example, implemented in the user terminal of the system of FIG. 1.

The receiver 900 includes means for receive processing 910 configured to receive and process a wireless signal, such as a layer modulated RF signal. The output of the means for receive processing 910 is coupled to a means for frequency transforming 920 configured to transform a received signal, such as a layer modulated OFDM symbol, to a frequency domain signal. For example, an OFDM symbol can be transformed to a plurality of subcarriers, each of which can be modulated with a layered modulation signal.

The output of the means for frequency transforming 920 is coupled to a means for channel estimation 930 and a means for subcarrier symbol deinterleaving 940. The means for channel estimation 930 can be configured to generate a channel estimate, can be configured to generate a channel estimate for a plurality of subcarriers of the OFDM symbol. The means for channel estimation 930 can include means for filtering the plurality of channel estimates. The means for filtering the plurality of channel estimates can include means for comparing an actual channel estimate component to a channel estimation threshold value. The means for filtering the plurality of channel estimates can also include means for selecting as a channel estimate component, one of the actual channel estimate component or a predetermined value, based on the comparison.

The means for subcarrier symbol deinterleaving 940 can be configured to separate the base layer and enhancement layer symbols from the received signal and can route the symbols to respective decoder paths. The base layer decoder path and the enhancement layer decoder paths can be substantially independent, and the enhancement layer decoder can operate concurrent with the base layer decoder.

A base layer decoder path includes a means for determining a base layer bit metric 950 coupled to the means for subcarrier symbol deinterleaving 940. The means for determining a base layer bit metric 950 is configured to determine a signal metric, such as a LLR for turbo encoded signals. The output of the means for determining a base layer bit metric 950 is coupled to a means for decoding the base layer 970.

The means for decoding the base layer 970 can include a means for determining a quality metric 972. For example, the means for determining a quality metric 972 can be configured to determine a signal quality metric based on the base layer data. The signal quality metric can be, for example, a SNR, Energy Estimate, or some other signal quality metric. The means for determining a quality metric 972 can couple the signal quality metric value to the means for channel estimation 930.

The enhancement layer decoder path is similar to the base layer decoding path. A means for determining an enhancement layer bit metric 960 is coupled to the means for subcarrier symbol deinterleaving 940. The output of the means for determining an enhancement layer bit metric 960 is coupled to a means for decoding the enhancement layer 980.

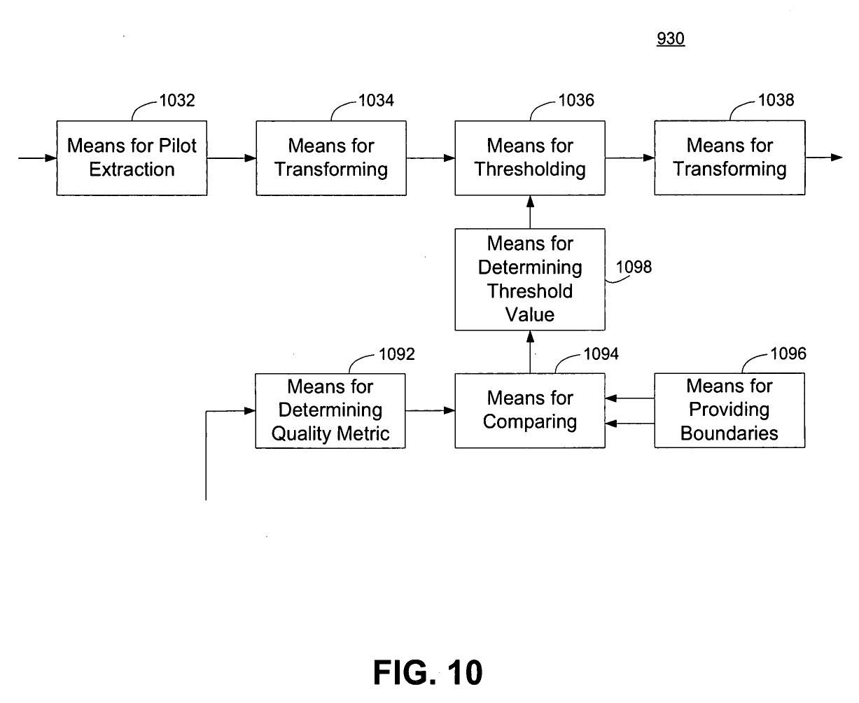

FIG. 10 is a simplified functional block diagram of an embodiment of a means for channel estimation 930 in a receiver. The means for channel estimation 930 can be the one shown in the receiver embodiment of FIG. 9.

The means for channel estimation 930 includes a channel estimation path including a means for pilot extraction 1032 coupled to a means for transforming the extracted pilots 1034. The output of the means for transforming the extracted pilots 1034 is coupled to a means for thresholding the channel estimates 1036. The output of the means for thresholding the channel estimates 1036 is coupled to a second means for transforming the channel estimates 1038 to produce transformed channel estimates.

The means for channel estimation 930 includes a threshold adapting path. The threshold adapting path includes a means for determining a quality metric 1092 coupled to a means for comparing the quality metric against one or more boundary values supplied by a means for providing boundaries 1096. The result from the means for comparing the quality metric 1098 is coupled to a means for determining a threshold value 1098 configured to determine a threshold value or threshold coefficient based on the comparison. The threshold value or threshold coefficient is coupled to the means for thresholding the channel estimates 1036 where channel estimate components can be filtered using the threshold value or threshold coefficient.

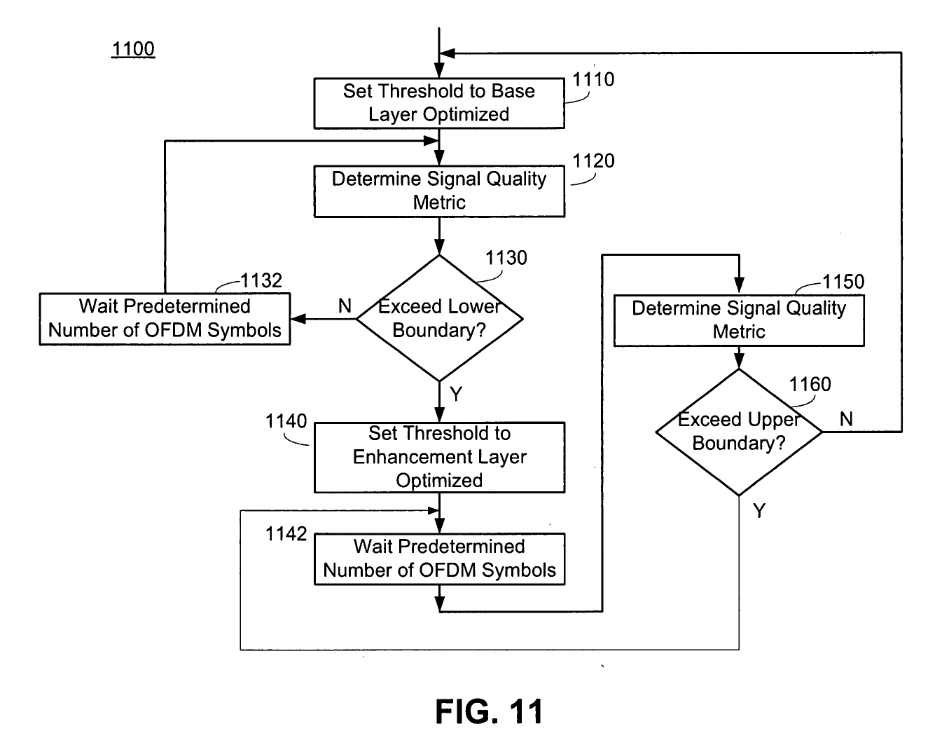

FIG. 11 is a simplified flowchart of a method 1100 of adapting a channel estimation threshold value in a layered modulation system. The method 1100 can be performed, for example, by a receiver in the system of FIG. 1.

The method begins at block 1110 where the receiver initially sets the threshold to a threshold value or threshold coefficient value optimized for the base layer decoding. After setting the initial value, the receiver proceeds to block 1120 and determines a signal quality metric, such as a Symbol Error Rate, Packet Error Rate, or Bit Error Rate. The receiver can determine the value directly or can estimate the value based on some other signal metric, such as a SNR.

The receiver proceeds to decision block 1130 where the receiver compares the signal quality metric against a predetermined lower boundary. If the signal quality metric does not exceed the lower boundary, the receiver proceeds to block 1132 to wait for a predetermined number of OFDM symbols, or some other predetermined period of time, and returns to block 1120 without changing the threshold value.

If, at decision block 1130, the receiver determines that the signal quality metric exceeds the lower boundary, the receiver proceeds to block 1140 and sets the threshold or threshold coefficient value to a value optimized for decoding the enhancement layer. Th receiver proceeds to block 1142 to wait a predetermined period of time, such as a time corresponding to a duration of a predetermined number of OFDM symbols.

The receiver proceeds to block 1150 and determines the signal quality metric. The receiver then proceeds to decision block 1160 and compares the signal quality metric against an upper boundary value. If the signal quality metric does not exceed the upper boundary value, the receiver returns to block 1110 where the threshold value is returned to the value optimized for the base layer. If, at decision block 1160, the receiver determines that the signal quality metric exceeds the upper boundary, the receiver returns to block 1142 to wait a predetermined period before updating the signal quality metric without changing the threshold value.

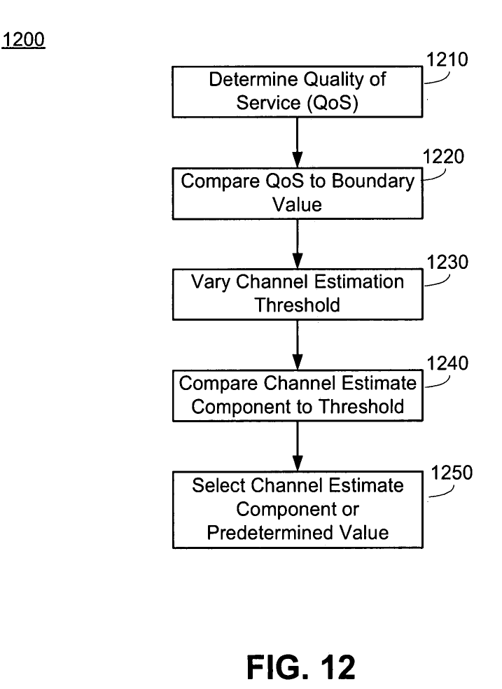

FIG. 12 is a simplified flowchart of a method 1200 of adapting a channel estimation threshold value in a layered modulation system. The method 1200 can be performed, for example, by a receiver in the system of FIG. 1.

The method begins at block 1210 where the receiver determines a quality of service value. The receiver proceeds to block 1220 and compares the quality of service value against a boundary value.

The receiver proceeds to block 1230 and varies or otherwise adapts the channel estimation threshold value or a threshold coefficient based on the comparison. The receiver proceeds to block 1240 and compares one or more channel estimate signal components, such as time domain taps, against the channel estimation threshold or a threshold determined using the channel estimation threshold coefficient the receiver proceeds to block 1250 and selects one of a channel estimate component value or a predetermined value based on the comparison.

Methods and apparatus for a receiver configured to decode base layer and enhancement layer data substantially concurrently and substantially in parallel have been described herein. The receiver can be configured to decode layered modulation data, where the underlying base and enhancement layer data has been encoded, such as by using a turbo encoder. The received signals can be single channel signals or can be multi-channel signals, with each of the multiple channels carrying layered modulation, and each layered modulation can have a different energy ratio. The receiver can substantially independently decode each of the channels.

Each of the base layer and enhancement layer decoders can include a bit metric module configured to provide a metric based on the received signal quality. The metric can be a log likelihood ratio (LLR) when the signals are turbo encoded. The log likelihood ratio can be an exact LLR value or can be an estimated LLR value. The estimated LLR value can be an estimate determined based in part on the maximum ratio corresponding to one of the constellation points in the layered modulation constellation.

The LLR values can depend on the received signal magnitude and the channel estimate. The bit metric modules can further be configured to utilize a channel estimate threshold value that can be used to determine whether an actual channel estimate or a predetermined value is used for the channel estimate. The base layer and enhancement layer decoders, and the corresponding bit metric modules, can utilize use a channel estimate based on channel estimate threshold values that are optimized for the particular layer of data. Alternatively, the base and enhancement layer decoders can use the same channel estimate threshold value, trading off some signal quality for simplified implementation. The channel estimator can use affixed channel threshold value or can vary the channel threshold value based on the received signal. In one embodiment, the channel estimator can vary the channel estimation threshold value by varying a threshold coefficient.

The channel estimator can vary the channel estimation threshold based on the received signal. For example, the channel estimator can vary the channel estimation threshold based on a quality of service metric, or a metric related to the quality of service, such as a signal to noise ratio.

The various illustrative logical blocks, modules, and circuits described in connection with the embodiments disclosed herein may be implemented or performed with a general purpose processor, a digital signal processor (DSP), a Reduced Instruction Set Computer (RISC) processor, an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method, process, or algorithm described in connection with the embodiments disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed embodiments is provided to enable any person of ordinary skill in the art to make or use the disclosure. Various modifications to these embodiments will be readily apparent to those of ordinary skill in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. A method of adapting a channel estimation threshold value in a layered modulation system, the method comprising:
determining a quality of service from a base layer of a received OFDM symbol modulated with layered modulation; and
varying the channel estimation threshold value based on the quality of service.

2. The method of claim 1, wherein determining the quality of service comprises estimating a symbol error rate of the base layer.

3. The method of claim 1, wherein determining the quality of service comprises determining one of a Signal to Noise Ratio or Energy Estimate of a base layer symbol.

4. The method of claim 1, wherein varying the channel estimation threshold value comprises varying a threshold coefficient.

5. The method of claim 4, wherein varying the threshold coefficient comprises selecting one of a base layer optimized threshold coefficient or an enhancement layer optimized threshold coefficient based on the quality of service.

6. The method of claim 1, further comprising:
comparing the quality of service from the base layer to at least one boundary value; and
setting a threshold coefficient based on the comparison.

7. The method of claim 1, further comprising filtering a time domain channel estimate using the channel estimation threshold value.

8. The method of claim 1, further comprising:
comparing each of a plurality of channel estimate components to the channel estimation threshold value; and
selecting, for each of the plurality of channel estimate components, one of the channel estimate component value or a predetermined value.

9. A method of adapting a channel estimation threshold value in a layered modulation system, the method comprising:
a) setting a threshold coefficient to a value that is optimized for a base layer decoder;
b) determining an energy estimate from a turbo decoder of the base layer; and
c) setting threshold coefficient to a value optimized for an enhancement layer decoder if the energy estimate is greater than a lower boundary value.

10. The method of claim 9, further comprising:
d) waiting a predetermined number of OFDM symbols; and
e) returning to step b) if the energy estimate is not larger than the lower boundary.

11. The method of claim 9, further comprising:
d) waiting a predetermined number of OFDM symbols;
e) determining the energy estimate from the turbo decoder of the base layer after the predetermined number of OFDM symbols; and
f) changing the threshold coefficient to the value optimized for the base layer if the energy estimate is less than an upper boundary value.

12. The method of claim 11, further comprising returning to step b).

13. The method of claim 11, further comprising returning to step d) if the energy estimate is larger than the upper boundary value.

14. A receiver in a layered modulation system, the receiver comprising:
a RF front end configured to receive a layered modulation symbol over a wireless link;
a channel estimator coupled to the RF front end and configured to generate a channel estimate based on the layered modulation symbol and a variable channel estimation threshold value;
a symbol deinterleaver coupled to the RF front end and configured to extract a base layer symbol and an enhancement layer symbol from the layered modulation symbol;
a base layer decoder coupled to the symbol deinterleaver and configured to determine a base layer data from the base layer symbol and the channel estimate; and
an enhancement layer decoder coupled to the symbol deinterleaver and configured to determine an enhancement layer data from the enhancement layer symbol and the channel estimate.

15. The receiver of claim 14, wherein the base layer decoder comprises a turbo decoder configured to generate a signal quality metric and wherein the channel estimator is configured to vary the channel estimation threshold value based in part on the signal quality metric.

16. The receiver of claim 14, wherein the channel estimator is configured to vary the channel estimation threshold value based in part on an estimated quality of service determined from the base layer symbol.

17. The receiver of claim 14, wherein the channel estimator is configured to compare each of a plurality of channel estimate components to the channel estimation threshold value, and select, for each of the plurality of channel estimate components, one of the channel estimate component value or a predetermined value.

18. The receiver of claim 14, wherein the channel estimator is configured to vary a channel coefficient that scales an average channel estimate.

19. The receiver of claim 14, wherein the channel estimator is configured to select one of a base layer optimized channel estimation threshold value and an enhancement layer optimized threshold value.

20. The receiver of claim 14, wherein the layered modulation symbol comprises an OFDM symbol having at least one subcarrier modulated with the layered modulation symbol.

21. The receiver of claim 14, wherein the channel estimator comprises:
a quality metric module configured to generate a quality of service estimate based on a signal received from the base layer decoder;
a metric boundary value configured to store at least one threshold value;
a comparator configured to compare the quality of service estimate to the at least one threshold value and provide a signal at a comparator output; and
a threshold value determination module configured to vary the channel estimation threshold value based on the signal at the comparator output.

22. A processor readable storage device configured to store one or more processor usable instructions, the instructions comprising:
determining a quality of service from a base layer of a received OFDM symbol modulated with layered modulation; and
varying the channel estimation threshold value based on the quality of service.

23. The processor readable storage device of claim 22, wherein the instructions further comprise:
comparing the quality of service from the base layer to at least one boundary value; and
setting a threshold coefficient based on the comparison.

24. The processor readable storage device of claim 22, wherein the instructions further comprise:
comparing each of a plurality of channel estimate components to the channel estimation threshold value; and
selecting, for each of the plurality of channel estimate components, one of the channel estimate component value or a predetermined value.

25. A receiver in a layered modulation system, the receiver comprising:
means for determining a quality of service from a base layer of a received OFDM symbol modulated with layered modulation; and
means for varying the channel estimation threshold value based on the quality of service.

26. The receiver of claim 25, wherein the means for determining the quality of service comprises means for estimating a symbol error rate of the base layer.

27. The receiver of claim 25, wherein the means for determining the quality of service comprises means for determining one of a Signal to Noise Ratio or Energy Estimate of a base layer symbol.

28. The receiver of claim 25, wherein the means for varying the channel estimation threshold value comprises means for varying a threshold coefficient by selecting one of a base layer optimized threshold coefficient or an enhancement layer optimized threshold coefficient based on the quality of service.

29. A receiver in a layered modulation system, the receiver comprising:
means for setting a threshold coefficient to a first value;
means for determining an energy estimate from a turbo decoder of a base layer; and
means for setting the threshold coefficient to a second value if the energy estimate is greater than a lower boundary value.

30. The receiver of claim 29, wherein the first value comprises a threshold coefficient value that is optimized for a base layer decoder.

31. The receiver of claim 29, wherein the second value comprises a threshold coefficient value that is optimized for an enhancement layer decoder.
